(19) United States
(12) Patent Application Publication
(10) Pub. No.: US 2009/0234942 A1
(43) Pub. Date: Sep. 17, 2009

(54) APPARATUS, SYSTEM, AND METHOD FOR TESTING EMBEDDED DEVICE

(75) Inventors: Ya-Bin Liu, Shenzhen City (CN); Ping Liu, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO.,LTD., Shenzhen City (CN); HON HAI PRECISION INDUSTRY CO., LTD., Tu-Cheng (TW)

(21) Appl. No.: 12/253,533

(22) Filed: Oct. 17, 2008

(30) Foreign Application Priority Data
Mar. 17, 2008 (CN) 200810300606.1

(51) Int. Cl. G06F 15/16

(52) U.S. Cl. 709/224

(57) ABSTRACT

An apparatus is used for testing an embedded device with identification information. The apparatus includes a storage device. A monitoring program and a testing program are installed in the storage device. The monitoring program receives the identification information from the embedded device through a serial connection formed between the apparatus and the embedded device after logging in to the embedded device through the serial connection. The testing program is copied to the embedded device to test the embedded device by the monitoring program through a network connection formed between the apparatus and the embedded device. A system and a method for testing the embedded device are also provided.

### BACKGROUND

1. Technical Field

The present disclosure relates to an apparatus, a system, and a method for testing an embedded device with an operating system and a plurality of programs burned in the embedded device as firmware.

2. Description of the Related Art

An embedded device has an operating system and a plurality of programs burned in the embedded device as firmware. In testing the embedded device, the embedded device and a computer system communicating with the embedded device are started. A testing program stored in the computer system is copied to the embedded device by an operator, and then the embedded device is restarted. After the embedded device is restarted, the operator starts the testing program and thereby tests the embedded device. The above method for testing the embedded device is inefficient.

Another method for testing the embedded device is provided by burning special instructions into the firmware of the embedded device. In testing the embedded device, the testing program can automatically test the embedded device under control of the special instructions. However, although this method is more efficient, the requirement of modifying the firmware with special instructions leaves room for improvement.

What is needed, is an apparatus, a system, and a method for automatically testing embedded devices without permanently modifying firmware of the embedded devices.

### BRIEF DESCRIPTION OF THE DRAWINGS

FIG. 1 is a block diagram of an embodiment of an apparatus and an embedded device.

FIG. 2 is a block diagram of a storage device of the apparatus of FIG. 1.

FIG. 3 is a flow chart illustrating a method using the apparatus of FIG. 1 to test the embedded device.

### DETAILED DESCRIPTION OF THE EMBODIMENTS

Many aspects of the embodiments can be better understood with reference to the drawings. The components in the drawings are not necessarily drawn to scale, the emphasis instead being placed upon clearly illustrating the principles of the embodiments. Moreover, in the drawings, like reference numerals designate corresponding parts throughout the several views.

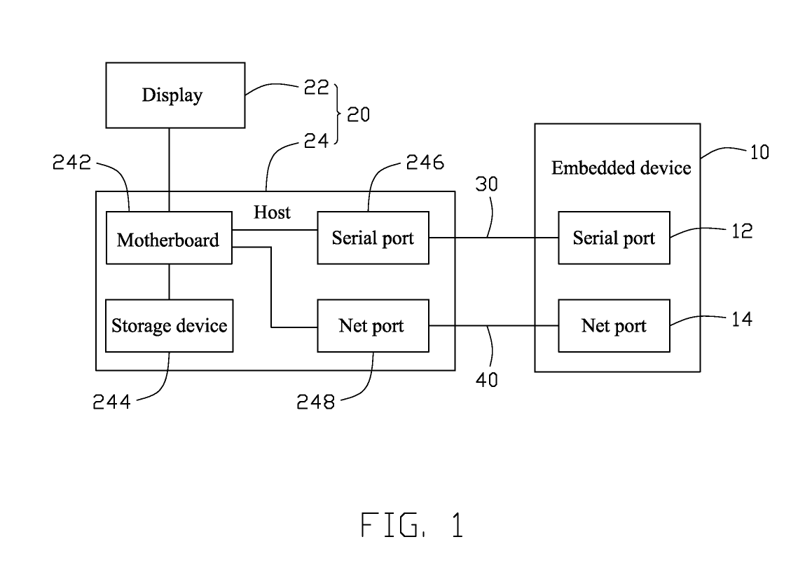

FIG. 1 illustrates an embodiment of an apparatus for testing an embedded device 10. An operating system and a plurality of programs are burned in the embedded device 10 as firmware. The programs are capable of performing functions of the embedded device 10 after the operating system has started. A serial port 12 and a network port 14 are provided in the embedded device 10.

The apparatus may be a computer system 20, and includes a display 22 and a host 24 communicating with the display 22. The host 24 includes a motherboard 242 and a storage device 244 communicating with the motherboard 242. A serial port 246 and a network port 248 are formed on the motherboard 242. A serial cable 30 is electrically coupled to the serial port 246 of the motherboard 242 and the serial port 12 of the embedded device 10, to establish a serial connection between the embedded device 10 and the motherboard 242 when the embedded device 10 and the host 24 are operating. A network cable 40 is electrically coupled to the network port 248 of the motherboard 242 and the network port 14 of the embedded device 10, to establish a network connection between the embedded device 10 and the motherboard 242 when the embedded device 10 and the host 24 are operating.

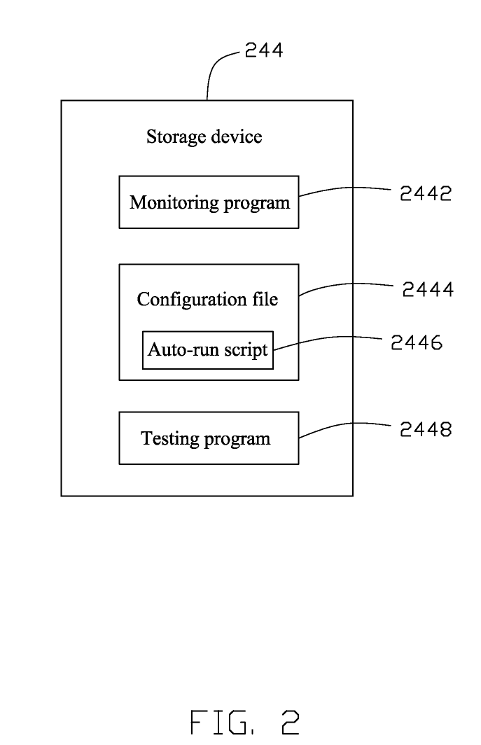

Referring also to FIG. 2, a monitoring program 2442 capable of performing monitoring functions is installed in the storage device 244 of the host 24. A configuration file 2444 and a testing program 2448 are stored in the storage device 244. The configuration file 2444 has a predetermined login username, a predetermined login password, and an auto-run script 2446. The predetermined login username and password can be used to log in to the embedded device 10. The auto-run script 2446 defines listing and items of the testing program 2448 to test the embedded device 10.

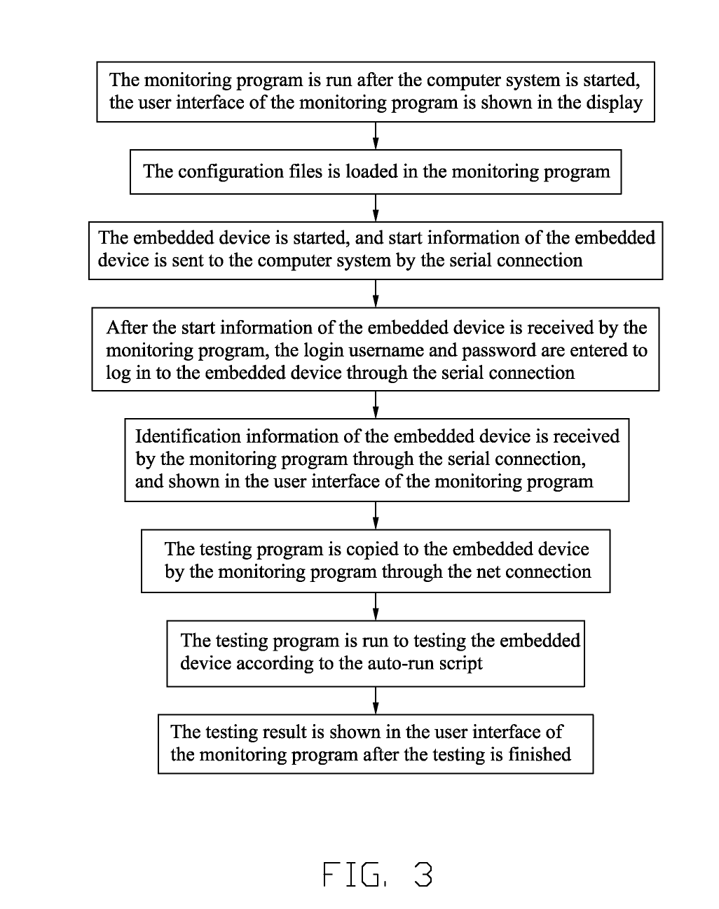

Referring also to FIG. 3, in testing the embedded device 10, the monitoring program 2442 is run after the host 24 of the computer system 20 is started, and a user interface of the monitoring program 2442 may be shown in the display 22. The monitoring program 2442 is capable of monitoring the status of the embedded device 10 by analysis of information received from the serial port 12 of the embedded device 10 through the serial connection. In the user interface of the monitoring program 2442, an auto mode and a manual mode can be selected for logging in to the embedded device 10. If the auto mode is selected, the predetermined login username and password stored in the configuration file 2444 can be automatically used to log in to the embedded device 10, and the parameters of the serial ports 12 and the network ports 14 cannot be modified. If the manual mode is selected, another login username and another login password, except the determined login username password, can be manually inputted to log in to the embedded device 10, and the parameters of the serial ports 12 and the network ports 14 can be manually modified if needed.

The configuration file 2444 is loaded in the monitoring program 2442. The embedded device 10 is started, and start information of the embedded device 10 is sent to the computer system 20 through the serial connection. After the start information of the embedded device 10 is received by the monitoring program, the login username and password are automatically entered to log in to the embedded device 10 through the serial connection if the auto mode is selected, or manually entered if the manual mode is selected. After the monitoring program 2442 logs in to the embedded device 10, identification information of the embedded device 10, such as a media access control (MAC) address or an internet protocol (IP) address, is received by the monitoring program 2442 through the serial connection, and shown in the user interface of the monitoring program 2442. The testing program 2448 is copied to the embedded device 10 by the monitoring program 2442 through the network connection. The testing program 2448 is run to test the embedded device 10 according to the auto-run script 2446. The testing procedure and the status are monitored by the monitoring program 2442, and shown in the user interface of the monitoring program 2442. After the testing of the embedded device 10 according to the auto-run script 2446, the testing program 2448 is deleted from the embedded device 10, and the testing result is shown in the user interface of the monitoring program 2442.

In one embodiment, the testing program 2448 is copied to the embedded device by the monitoring program 2442 through the network connection, and started by the monitoring program 2442 to test the embedded device 10 according to the auto-run script 2446, then deleted from the embedded device 10 by the monitoring program 2442. Thus, the testing program 2442 does not permanently modify the firmware of the embedded device 10.

Furthermore, the testing procedure and the testing result is received by the monitoring program 2442 and shown in the user interface through the network connection, but not the serial connection. Because information transmitting velocity of the network connection is greater than information transmitting velocity of the serial connection, the testing efficiency is improved and the testing time is decreased.

It is to be understood, however, that even though numerous characteristics and advantages have been set forth in the foregoing description of embodiments, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An apparatus for testing an embedded device with identification information, comprising:
a storage device, wherein a monitoring program and a testing program is installed in the storage device, the monitoring program receives the identification information from the embedded device through a serial connection formed between the apparatus and the embedded device after logging in to the embedded device through the serial connection, the testing program is copied to the embedded device to test the embedded device by the monitoring program through a network connection formed between the apparatus and the embedded device.

2. The apparatus of claim 1, wherein an auto-run script is stored in the storage device and defines listing and items to test the embedded device.

3. The apparatus of claim 1, wherein a configuration file is stored in the storage device, and has a predetermined username and a predetermined password, the monitoring program logs in to the embedded device with the predetermined username and the predetermined password of the configuration file when an auto mode of the monitoring program is selected.

4. The apparatus of claim 1, wherein the monitoring program logs in to the embedded device by manually entering a username and a password when a manual mode of the monitoring program is selected.

5. A method for an apparatus for testing an embedded device with identification information, the method comprising:
receiving the identification information of the embedded device by a monitoring program installed in the apparatus through a serial connection between the apparatus and the embedded device after the monitoring program logs in to the embedded device through the serial connection;
copying a testing program stored in the apparatus to the embedded device through a network connection between the apparatus and the embedded device; and
testing the embedded device according to an auto-run script loaded in the monitoring program.

6. The method of claim 5, wherein the auto-run script defines listing and items according to which the testing program tests the embedded device.

7. The method of claim 5, further comprising logging in to the embedded device by automatically entering a predetermined username and a predetermined password.

8. The method of claim 5, further comprising logging in to the embedded device by manually entering a username and a password.

9. The method of claim 5, wherein the identification information is an internet protocol address or a media access control address.

10. A system comprising:
an embedded device with identification information;
an apparatus having a serial connection and a network connection formed between the embedded device and the apparatus, wherein a monitoring program is installed in the apparatus, logs in to the embedded device through the serial connection after the embedded device is started, and receives the identification information from the embedded device through the serial connection so that the network connection is applicable; a testing program stored in the apparatus is copied to the embedded device for testing the embedded device by the monitoring program through the network connection.

11. The system of claim 10, further comprising an auto-run script is stored in the apparatus and defines listing and items to test the embedded device.

12. The system of claim 10, wherein a configuration file stored in the apparatus has a predetermined username and a predetermined password; the monitoring program logs in to the embedded device with the predetermined username and the predetermined password when an auto mode of the monitoring program is selected.

13. The system of claim 10, wherein the monitoring program logs in to the embedded device by manually entering a username and a password when a manual mode of the monitoring program is selected.

14. The system of claim 10, wherein the identification information is an internet protocol address or a media access control address.
